(19) United States
(12) Patent Application Publication
(10) Pub. No.: US 2015/0153172 A1
(43) Pub. Date: Jun. 4, 2015

(54) Photography Pose Generation and Floorplan Creation

(71) Applicants: Alexander Thomas STARNS, Redwood City, CA (US); Jichao Li, Charlottesville, VA (US); Mark Christopher Colbert, San Mateo, CA (US)

(72) Inventors: Alexander Thomas STARNS, Redwood City, CA (US); Jichao Li, Charlottesville, VA (US); Mark Christopher Colbert, San Mateo, CA (US)

(73) Assignee: Google Inc., Mountain View, CA (US)

(21) Appl. No.: 13/350,254

(22) Filed: Jan. 13, 2012

Related U.S. Application Data
(60) Provisional application No. 61/553,634, filed on Oct. 31, 2011.

(51) Int. Cl. G06K 9/36; G01C 11/02; G06T 7/60

(52) U.S. Cl. CPC G01C 11/02; G06T 7/602

(57) ABSTRACT

Systems, methods, and computer storage mediums are provided for positioning image markers on a virtual canvas. An exemplary method includes positioning one or more virtual objects on the virtual canvas. Each virtual object corresponds to a physical object located within the physical space. The position of each virtual object on the virtual canvas approximates the location of its corresponding physical object within the physical space. A plurality of image markers are also positioned on the virtual canvas. Each image marker's position on the virtual canvas corresponds to a physical location within the physical space where a photographic image's photo capture device was located when the photographic image was captured. A link between a first image marker and a second image marker is also created. The link indicates a path, traversable by a user, within the physical space between the physical locations represented by the first and second image markers.

This application claims the benefit of U.S. Provisional Application No. 61/553,634, filed Oct. 31, 2011, which is incorporated herein in its entirety by reference.

### FIELD

Embodiments disclosed herein generally relate to creating interactive presentations.

### BACKGROUND

Users wishing to view photographic images of real-world locations can readily visit a number of websites serving geographic information and select a real-world location from a map. An interactive photographic presentation can then be provided of the real-world location where the user can navigate through images of an outdoor space. The photographic images in the presentation are collected by a camera system that includes a camera attached to equipment that tracks the camera's location within the outdoor space. The equipment also records information about the outdoor space such as, for example, the dimension of the space. The information collected by the equipment is used to combine the photographic images into the interactive presentation.

Creating an interactive presentation of an indoor space also currently utilizes a camera attached to equipment that tracks the camera's movement within the indoor space. This equipment can be cumbersome to move around an indoor space and is often expensive and not easily distributable. As a result, interactive photographic presentations of indoor and outdoor spaces are not easily creatable.

### BRIEF SUMMARY

The embodiments described herein may be used to build an interactive photographic presentation of a physical space without the need of equipment attached to a camera to track the camera's position. A user may position a plurality of image markers in a location on a virtual canvas that approximately corresponds to where a collection of photographic images were captured within the physical space. The image markers can be linked based on a traversable path in the physical space. One or more virtual objects may also be represented on the virtual canvas that correspond to physical objects within the physical space. The virtual canvas can then be used to create an interactive presentation.

The embodiments described herein include systems, methods, and computer storage mediums for positioning image markers on a virtual canvas that represents a physical space captured in a collection of photographic images. An exemplary method includes positioning one or more virtual objects on the virtual canvas. Each virtual object corresponds to a physical object located within the physical space. The position of each virtual object on the virtual canvas approximates the location of its corresponding physical object within the physical space. A plurality of image markers are also positioned on the virtual canvas. Each image marker's position on the virtual canvas corresponds to a physical location within the physical space where a photographic image's photo capture device was located when the photographic image was captured. A link between a first image marker and a second image marker is also created. The link indicates a path, traversable by a user, within the physical space between the physical locations represented by the first and second image markers. The link is created based, at least in part, on input from the user and the position of the one or more virtual objects.

Further features and advantages of the embodiments described herein, as well as the structure and operation of various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1A illustrates an exemplary user interface that represents a virtual canvas according to an embodiment.

FIG. 1B illustrates the physical space that is represented on the virtual canvas in FIG. 1A.

FIG. 2 illustrates an example system environment that may be used to position image markers on a virtual canvas that represents a physical space captured in a collection of photographic images.

FIG. 3 is a flowchart illustrating an exemplary method that may be used to position image markers on a virtual canvas that represents a physical space captured in a collection of photographic images.

FIG. 4 illustrates an example computer in which embodiments of the present disclosure, or portions thereof, may be implemented as computer-readable code.

### DETAILED DESCRIPTION

In the following detailed description, references to “one embodiment,” “an embodiment,” “an example embodiment,” etc., indicate that the embodiment described may include a particular feature, structure, or characteristic. Every embodiment, however, may not necessarily include the particular feature, structure, or characteristic. Thus, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

This Detailed Description is divided into sections. The first and second sections describe example system and method embodiments that may be used to position a collection of photographic images on a virtual canvas that represents a physical space captured in the collection of photographic images. The third section describes an exemplary user-interface. The fourth section describes an example computer system that may be used to implement the embodiments described herein.

### Example User Interface

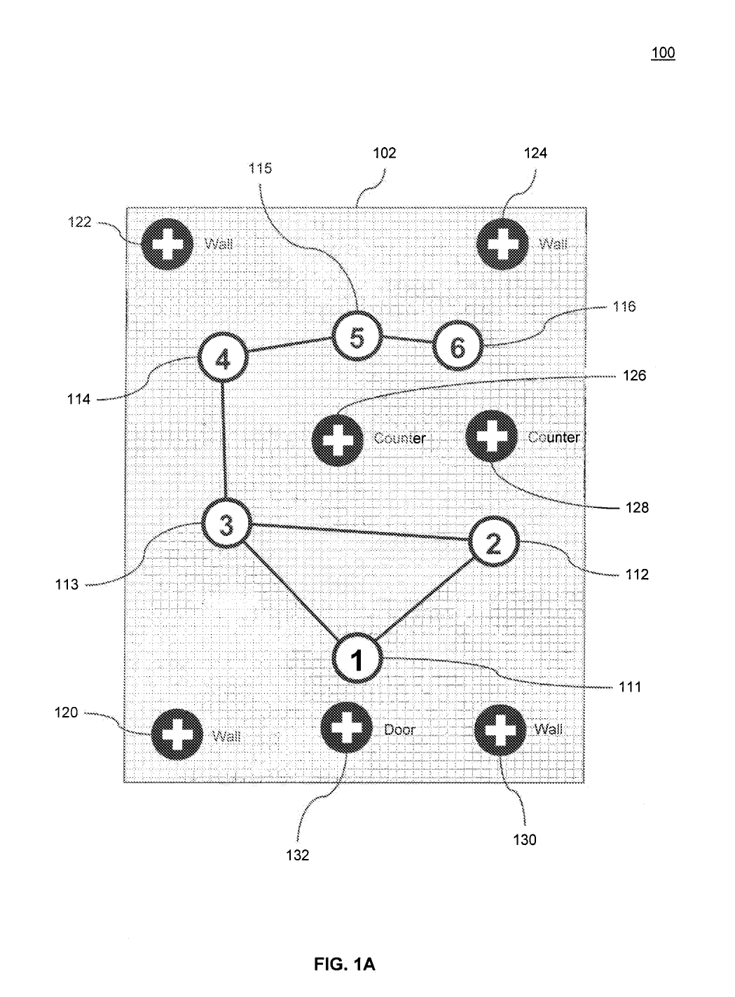

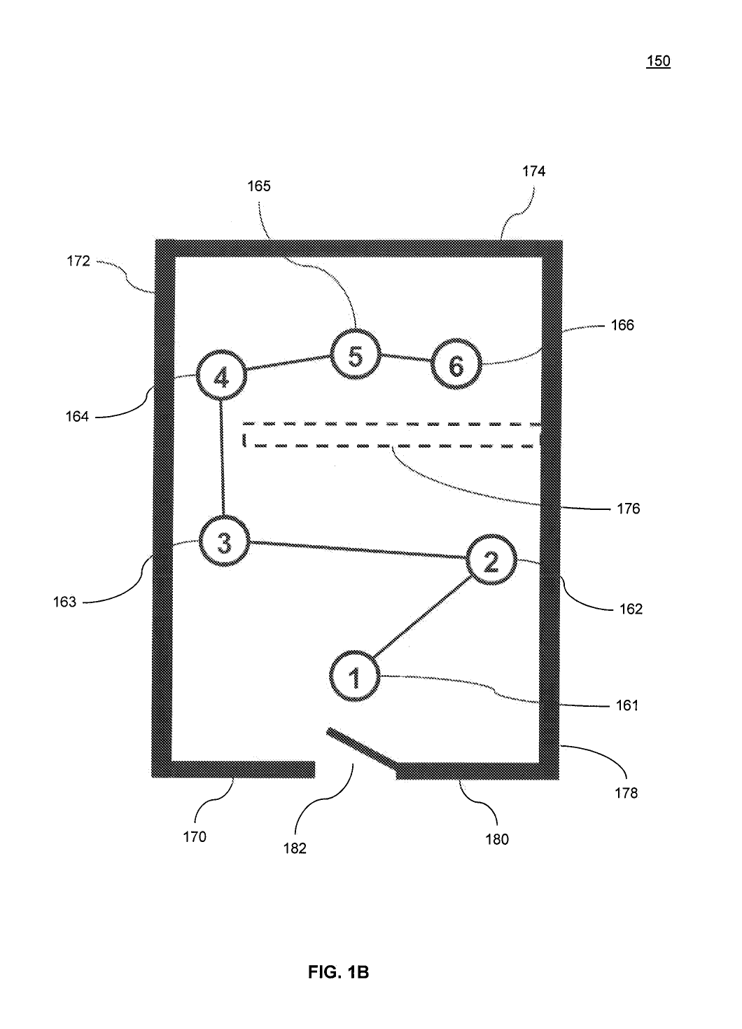

FIG. 1A illustrates an exemplary user interface 100 that represents a virtual canvas according to an embodiment. User interface 100 includes virtual canvas 102, image markers 111, 112, 113, 114, 115, and 116, and virtual objects 120, 122, 124, 126, 128, 130, and 132. FIG. 1B illustrates a floor plan 150 of the physical space that is represented on virtual canvas 102 in FIG. 1A. Floor plan 150 includes locations 161, 162, 163, 164, 165, and 166, walls 170, 172, 174, 178, and 180, door 182, and counter 176.

Image markers 111-116 each respectively represent locations 161-166. Locations 161-166 each represent where a photo capture device was located within the physical space represented by floor plan 150 when a photographic image was captured. The lines between locations 161-166 indicate a path traveled by a photographer when capturing the photographic images.

Virtual object 132 represents door 182 that exists within the physical space represented by the floor plan 150. Virtual objects 120, 122, 124, and 130 indicate the location of the endpoints of walls 170, 172, 174, 178, and 180 that exist within the physical space represented by floor plan 150. Virtual objects 126 and 128 represent the endpoints of counter 176 appearing in the physical space represented by floor plan 150.

After the image markers and virtual objects have been positioned on virtual canvas 102, links are created between image markers 111-116—represented in user-interface 100 as lines between image markers 111-116. The links may be determined by, for example, a user or may be determined based on the position or type of the virtual objects on virtual canvas 102. For example, a virtual object representing a non-traversable structure (e.g., a wall, a counter, a bar, a half wall, or a window) may prevent image markers on opposite sides from being linked. Alternatively, a traversable structure (e.g., a door) may allow image markers on opposite sides to be linked. In FIG. 1A, for example, virtual objects 126 and 128 represent a non-traversable structure that prevents image marker 112 from being linked with image markers 114, 115, and 116.

The links represent a path that can be traversed by a user navigating the physical space represented by floor plan 150. For example, the user navigating the physical space represented by floor plan 150 may traverse from the position represented by image marker 111 to the positions represented by either image marker 112 or 113. Once at the position represented by image marker 113, the user may navigate to the positions represented by either image marker 111, 112, or 114. Once at the position represented by image marker 114, however, the user may only navigate to the positions represented by image marker 113 or 115 due the counter represented by virtual objects 126 and 128 existing within the physical space. The links, when processed by scene construction module 212 or scene construction server 250, described below, determine how the user may navigate between the image markers' corresponding photographic images when viewing an interactive presentation from the photographic images.

User-interface 100 and floor plan 150 are provided as examples and are not intended to limit the embodiments described herein.

### Example System Embodiments

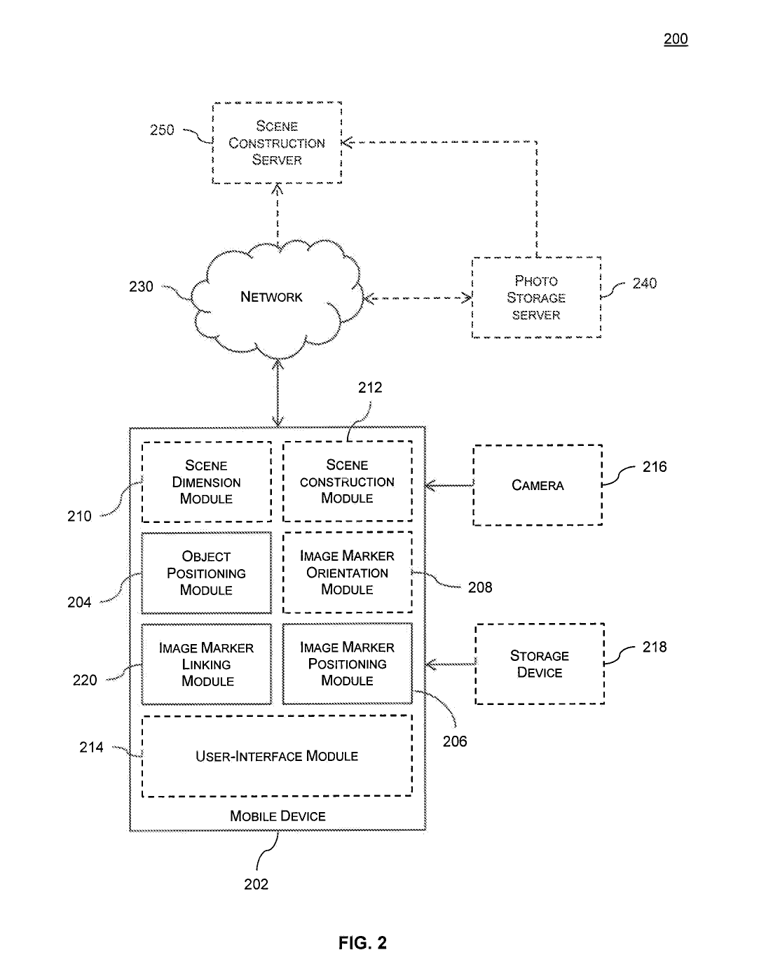

FIG. 2 illustrates an example system environment 200 that may be used to position image markers on a virtual canvas that represents a physical space captured in a collection of photographic images. System 200 includes mobile device 202, camera 216, storage device 218, network 230, photo storage server 240, and scene construction server 250. Mobile device 202 includes object positioning module 204, image marker positioning module 206, image marker orientation module 208, scene dimension module 210, scene construction module 212, user-interface module 214, and image marker linking module 220.

Network 230 may include any network or combination of networks that can carry data communication. These networks may include, for example, a local area network (LAN) or a wide area network (WAN), such as the Internet. LAN and WAN networks may include any combination of wired (e.g., Ethernet) or wireless (e.g., Wi-Fi, 3G, or 4G) network components. Mobile device 202 may connect to photo storage server 240 and scene construction server 250 via network 230.

Mobile device 202, photo storage server 240, and scene construction server 250 may be implemented on a computing device with a display that is configured to receive, capture, or store photographic images. Such a device can include, for example, a stationary computing device (e.g., desktop computer), a networked server, and a mobile computing device such as, for example, a tablet, a smartphone, or another network enabled portable digital device. A computing device may also include, but is not limited to, a central processing unit, an application-specific integrated circuit, a computer, workstation, distributed computing system, computer cluster, embedded system, stand-alone electronic device, networked device, mobile device (e.g. mobile phone, smart phone, personal digital assistant (PDA), navigation device, tablet or mobile computing device), rack server, set-top box, or other type of computer system having at least one processor and memory. A computing process performed by a clustered computing environment or server farm may be carried out across multiple processors located at the same or different locations. Hardware can include, but is not limited to, a processor, memory and user interface display.

Object positioning module 204, image marker positioning module 206, image marker orientation module 208, scene dimension module 210, scene construction module 212, user-interface module 214, and image marker linking module 220 may also run on any computing device. Each module may also run on a distribution of computing devices or a single computing device.

A. Mobile Device

Mobile device 202 is configured to position a plurality of image markers on a virtual canvas that represents a physical space captured in a collection of photographic images. The physical space can include both indoor and outdoor spaces. The photographic images that capture the physical space may have fields-of-view up to and include 360 degrees (e.g. panoramic images). In some embodiments, the collection of photographic images may be retrieved from any media source such as, for example, camera 216, storage device 218, or photo storage server 240. Camera 216 may include a built-in camera or an external camera. Storage device 218 may include a portable storage device such as, for example, a magnetic disk drive or a solid state memory device. Storage device 218 may be used to store photographic images captured by, for example, a digital camera.

1. Object Positioning Module

Mobile device 202 includes object positioning module 204. Object positioning module 204 is configured to position one or more virtual objects on a virtual canvas. Each virtual object corresponds to a physical object located within the physical space that is captured in the photographic images. The physical objects that can be represented by virtual objects include, for example, walls, windows, doorways, furniture, or other physical features. Virtual objects can be viewed on the virtual canvas as, for example, lines, shapes, icons, images, or representative graphics.

In some embodiments, the virtual canvas may be represented on a display unit operatively connected to mobile device 202. The display unit may be configured to receive touch-screen gestures. In some embodiments, a user may utilize touch-screen gestures that user-interface module 214 can use to position objects on the virtual canvas. The virtual canvas may be displayed on the display unit through user-interface module 214. In some embodiments, the virtual canvas is represented as a blank screen. In some embodiments, the virtual canvas includes a representation of the physical space as a blueprint or floor plan. In some embodiments, the virtual canvas is scaled to the dimension(s) of the physical space.

The position of each virtual object on the virtual canvas approximates the location of its corresponding physical object within the physical space. In some embodiments, a virtual object's position is based on user input. For example, a user viewing and capturing photographic images of a physical space may choose a virtual object representing a doorway and place it on the virtual canvas in a position corresponding to the doorway's location within the physical space. Selecting the type and position of the virtual object may be made by the user via, for example, user-interface module 214.

In some embodiments, object positioning module 204 is also configured to position at least one virtual object automatically based on the position of at least one image marker with a corresponding photographic image that captured the virtual object's corresponding physical object. For example, if the photographic image captures a portion of a wall, object positioning module 204 may automatically position a virtual object representing the wall at a corresponding position in the virtual canvas. To position virtual objects automatically, object orientation module may utilize information included in metadata associated with the photographic image such as, for example, the focal distance, focal length, or field-of-view.

In some embodiments, object positioning module 204 is also configured to position at least one virtual object on the virtual canvas based on a measured distance between the virtual object's corresponding physical object and one other physical object. For example, if the virtual canvas is configured to represent the physical space based on a scaling factor, a user may measure the distance between physical objects and utilize the distance measurement to position corresponding virtual objects. In some embodiments, a virtual object is positioned based on the measured distance between its corresponding physical object and a location where a photographic image was captured. In some embodiments, once virtual objects are positioned, a dimension of the physical space may be calculated by, for example, scene dimension module 210, described below.

2. Image Marker Positioning Module

Mobile device 202 also includes image marker positioning module 206. Image marker positioning module 206 is configured to position a plurality of image markers on the virtual canvas. Image markers can be positioned on the virtual canvas such that they reflect a corresponding photographic image's field-of-view. An image marker may be represented on the virtual canvas as a thumbnail of a corresponding photographic image, an icon, a graphic, or some other shape or figure. Once positioned, information may be associated with the image marker. Such information may include, for example, the name associated with the corresponding photographic image, the physical location where the image was captured, or a unique ID number.

Each image marker's position on the virtual canvas corresponds to a physical location in the physical space where a corresponding photographic image's photo capture device was located when the photographic image was captured. An image marker's position may be selected by the user or may be determined automatically based on the type and position of a virtual object or the position of other image markers. The position may also be based on a measured distance between physical objects or photographic image capture locations.

In some embodiments, an image marker's position on the virtual canvas is based on user input. For example, a user may place an image marker on the virtual canvas at a position corresponding to where a photo capture device was located when a corresponding photographic image was captured. The position selected by the user may be received by, for example, user-interface module 214, described above.

In some embodiments, image marker positioning module 206 is also configured to position an image marker automatically based on the virtual location of at least one virtual object. For example, if a virtual object's corresponding physical object is captured in a photographic image, photo positioning module 206 may approximately position an image marker that corresponds to the photographic image based on where the physical object is captured within the image. Image marker positioning module 206 may determine the position of the image marker relative to the physical object by utilizing metadata associated with the corresponding photographic image such as, for example, the image's focal length, focal distance, or field-of-view. Image marker positioning module 206 may also utilize the approximate dimension of the physical space and metadata associated with the physical object's corresponding virtual object, if provided.

In some embodiments, image marker positioning module 206 is also configured to position an image marker automatically based on the virtual location of at least one other image marker. For example, if a first image marker is positioned on the virtual canvas, image marker positioning module 206 may automatically place a second image marker on the virtual canvas if the corresponding photographic images capture at least a portion of the same scene. Metadata associated with either corresponding photographic image may be utilized to determine the position of the other image markers. Additionally, image marker positioning module 206 may utilize the dimension of the physical space, the position of virtual objects on the virtual canvas, or metadata associated with a virtual object.

3. Image Marker Linking Module

Mobile device 202 also includes image marker linking module 220. Image marker linking module 220 is configured to create a link between a first image marker and a second image marker. The link indicates a path within the physical space between the physical locations represented by the first and second image markers that is traversable by a user. The link is created, at least in part, based on input from the user and the position of the one or more virtual objects.

In some embodiments, the link may be included in a virtual presentation created from the photographic images that correspond to the image markers. The link may be represented as a line in a photographic image showing a traversable path with the space captured in the image. The line may be interactive such that when selected, a user will be navigate to the photographic image corresponding to the image marker on the other end of the link.

4. Image Marker Orientation Module

In some embodiments, mobile device 202 also includes image marker orientation module 208. Image marker orientation module 208 is configured to orient an image marker positioned on the virtual canvas such that a field-of-view captured in the corresponding photographic image aligns at least one physical object captured in the photographic image with its corresponding virtual object on the virtual canvas. The field-of-view of the photographic image indicates the extent of a scene observable by the image's capture device. Photographic images can have fields-of-view up to and including 360 degrees. The field of view may be represented on the image marker by, for example, graphically indicating the center of the field-of-view, the edges of the field-of-view, or the extent of the field-of-view.

Each image marker positioned on the virtual canvas may be associated with an orientation angle. The orientation angle describes the rotation of a corresponding photographic image's photo capture device about an axis of rotation that is based on a number of degrees from an initial orientation. In some embodiments, the initial orientation can be based on a wall or another physical object within the physical space. In some embodiments, the initial orientation is based on an accelerometer, a compass, or a gyroscope included in the photo capture device.

In some embodiments, the orientation angle is based on user input. For example, after an image marker is positioned on the virtual canvas, a user may select the image marker and rotate it about its axis such that the scene captured in the corresponding photographic image aligns with the virtual representation of the scene on the virtual canvas.

In some embodiments, image marker orientation module 208 is also configured to orient an image marker automatically based on the virtual location of at least one virtual object. In some embodiments, physical objects captured in a photographic image corresponding to an image marker are identified automatically. In some embodiments, physical objects are identified by the user. In some embodiments, a combination of manual and automatic recognition is utilized. For example, if a user selects an image marker and one or more virtual objects, image marker orientation module 208 will determine an orientation angle for the image marker that aligns the physical objects captured in the image marker's corresponding photographic image with its corresponding virtual object on the virtual canvas. Once determined, the orientation angle may be added to the metadata associated with the image marker or its corresponding photographic image.

4. Scene Dimension Module

In some embodiments, mobile device 202 also includes scene dimension module 210. Scene dimension module 210 is configured to determine an approximate physical dimension of the physical space based on the virtual location of each image marker and the virtual location of each virtual object. Scene dimension module 210 may determine the dimension of the physical space based on, for example, a scaling factor associated with the virtual canvas or the position of virtual objects and/or image markers on the virtual canvas.

In some embodiments, the dimension of the physical space is determined from a scaling factor. The scaling factor may include multiple components such as, for example, separate values for each dimension if the physical space is a square or more dimensions for irregular spaces. For example, if a user is photographing a physical space that is 20 feet by 20 feet, the user may choose to set a scaling factor such that one inch of the virtual canvas represents five feet of the physical space.

In some embodiments, the dimension of the physical space is based on the position of one or more virtual objects or image markers on the virtual canvas. For example, if the position of two virtual objects are based on a measured distance between their corresponding physical objects and the distance is associated with the virtual objects, scene dimension module 210 will utilize the distance to determine the physical space's dimensions.

In some embodiments, the dimension of the physical space may be determined by using metadata associated with the image marker's corresponding photographic images. For example, if two image markers positioned on the virtual canvas have corresponding photographic images that capture the same physical object from different angles, metadata associated with each photographic image may be used to determine the distance of the physical object from each respective image's camera position. This length, along with the orientation angle may be used to determine the physical space's dimension.

In some embodiments, scene dimension module 210 is also configured to generate a floor plan of the physical space based on the virtual objects included on the virtual canvas. For example, if the virtual objects include walls and a door, scene dimension module 210 may generate a floor plan using the positions of the walls and door as a guide. The floor plan, once generated, can be displayed on the virtual canvas.

5. Scene Construction Module

In some embodiments, mobile device 202 also includes scene construction module 212. Scene construction module 212 is configured to build a virtual walk-through-style presentation of the physical space based on the position of the image markers on the virtual canvas and the links between the image markers. The presentation allows the user to navigate from a first photographic image to a second photographic image along the path indicated by the link between the corresponding first and second image markers. The link between the image markers may be represented in the presentation by a line in a photographic image that shows a path that may be traversed to a location within the image where another photographic image was captured.

In some embodiments, scene construction module 212 may be implemented by scene construction server 250. Scene construction server 250 is configured to receive a data file from mobile device 202. The data file may include, for example, the position of each image marker, the position and type of each virtual object on the virtual canvas, and any information associated with the image markers or the virtual objects. Scene construction server 250 may utilize this data file to build an interactive presentation that allows a user to navigate through each image marker's corresponding photographic images based on where each image marker was positioned on the virtual canvas.

Various aspects of embodiments described herein may be implemented by software, firmware, hardware, or a combination thereof. The embodiments, or portions thereof, may also be implemented as computer-readable code. The embodiment in system 200 is not intended to be limiting in any way.

### Example Method Embodiments

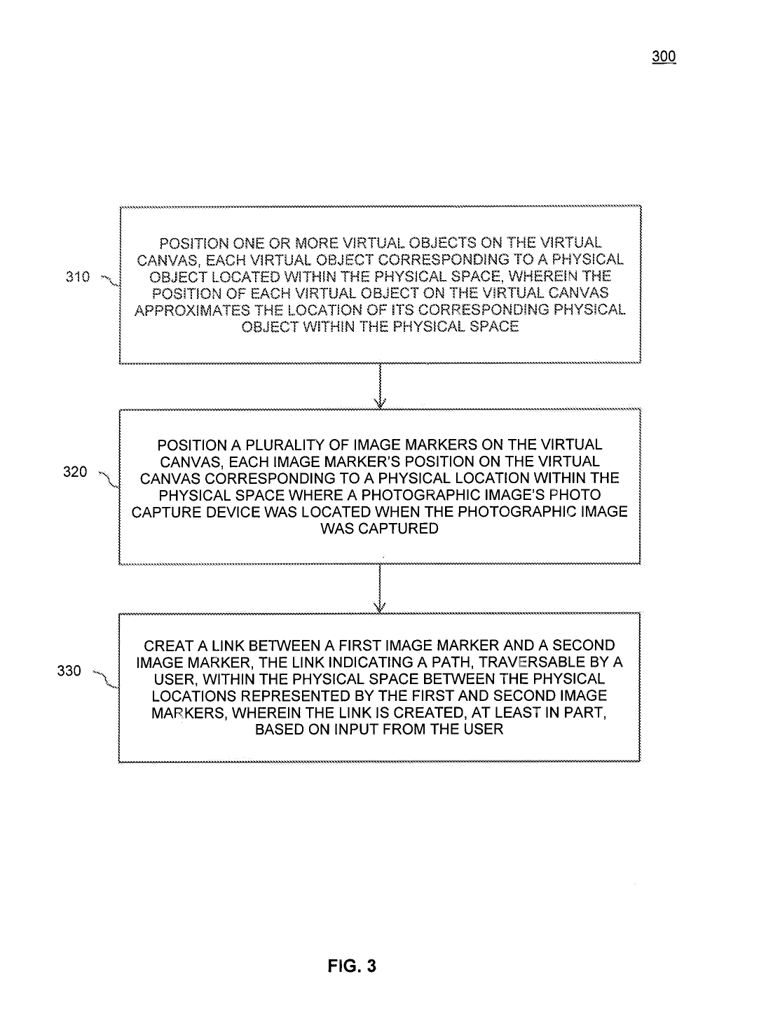

FIG. 3 is a flowchart illustrating an exemplary method 300 that may be used to position image markers on a virtual canvas that represents a physical space captured in a collection of photographic images. While method 300 is described with respect to an embodiment, method 300 is not meant to be limiting and may be used in other applications. Additionally, method 300 may be carried out by, for example, system 200.

Method 300 positions one or more virtual objects on the virtual canvas (stage 310). Each virtual object corresponds to a physical object located within the physical space. The position of each virtual object on the virtual canvas approximates the location of its corresponding physical object within the physical space. Physical objects that may be represented as virtual objects on the virtual canvas include, for example, walls, windows, doorways, furniture, or other features within the physical space. The virtual objects may be represented as shapes, icons, or graphics depicting the physical object. The position of the virtual objects may be based on a measured distance between the physical objects, where the physical objects appear in the photographic images corresponding to image markers, or user input. Stage 310 may be carried out by, for example, object positioning module 204 embodied in system 200.

Method 300 also positions a plurality of image markers on the virtual canvas (stage 320). Each image marker's position on the virtual canvas corresponds to a physical location within the physical space where a photographic image's photo capture device was located when the photographic image was captured. The image markers may indicate a corresponding photographic image's field-of-view up. Each image marker may be positioned based on the position of other image markers, the position of one or more virtual objects, or user input. The image markers may also be positioned based on a measured distance between the camera's locations when capturing the corresponding photographic images. Stage 320 may be carried out by, for example, image marker positioning module 206 embodied in system 200.

Method 300 also creates a link between a first image marker and a second image marker (stage 330). The link indicates a path within the physical space between the physical locations represented by the first and second image markers that is traversable by a user. The link is created, at least in part, based on input from the user and the position of the one or more virtual objects. Stage 330 may be carried out by, for example, image marker linking module 220 embodied in system 200.

In some embodiments, method 300 also orients an image marker positioned on the virtual canvas such that a field-of-view captured in the corresponding photographic image aligns at least one physical object captured in the photographic image with its corresponding virtual object on the virtual canvas. The image marker is oriented by rotating it about an axis on the virtual canvas. The location of the axis on the virtual canvas corresponds to the location of a corresponding photographic image's capture device when the image was captured. Thus, the image marker and its axis may be located at the same position on the virtual canvas. The image marker may be oriented based on, for example, the physical objects captured in a corresponding photographic image, the virtual objects on the virtual canvas, or the location of other image markers with corresponding photographic images that captured portions of the same scene. This stage may be carried out by, for example, image marker orientation module 208 embodied in system 200.

### Example Computer System

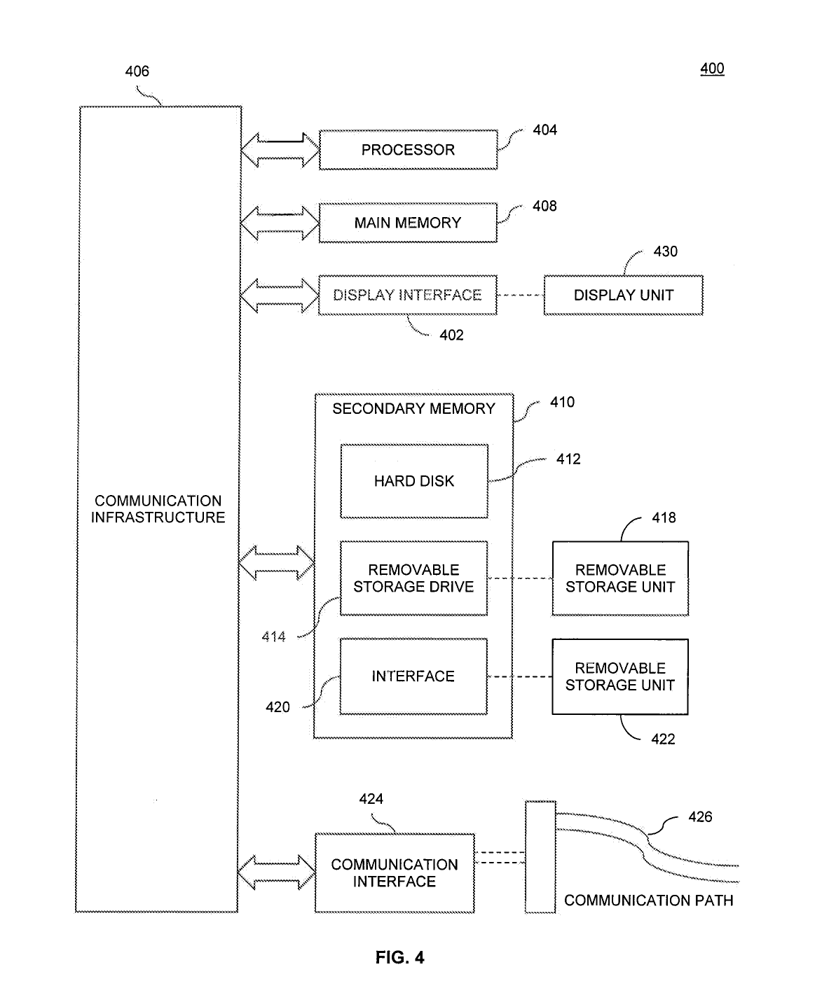

FIG. 4 illustrates an example computer system 400 in which embodiments of the present disclosure, or portions thereof, may be implemented. For example, object positioning module 204, photo positioning module 206, photo orientation module 208, scene dimension module 210, and scene construction module 212 may be implemented in one or more computer systems 400 using hardware, software, firmware, computer readable storage media having instructions stored thereon, or a combination thereof.

One of ordinary skill in the art may appreciate that embodiments of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above described embodiments. A processor device may be a single processor, a plurality of processors, or combinations thereof. Processor devices may have one or more processor “cores.”

Various embodiments are described in terms of this example computer system 400. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons skilled in the relevant art, processor device 404 may be a single processor in a multi-core/multiprocessor system, such system operating alone, or in a cluster of computing devices operating in a cluster or server farm. Processor device 404 is connected to a communication infrastructure 406, for example, a bus, message queue, network, or multi-core message-passing scheme.

Computer system 400 also includes a main memory 408, for example, random access memory (RAM), and may also include a secondary memory 410. Secondary memory 410 may include, for example, a hard disk drive 412, and removable storage drive 414. Removable storage drive 414 may include a floppy disk drive, a magnetic tape drive, an optical disk drive, a flash memory drive, or the like. The removable storage drive 414 reads from and/or writes to a removable storage unit 418 in a well-known manner. Removable storage unit 418 may include a floppy disk, magnetic tape, optical disk, flash memory drive, etc. which is read by and written to by removable storage drive 414. As will be appreciated by persons skilled in the relevant art, removable storage unit 418 includes a computer readable storage medium having stored thereon computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 may be in the form of signals, which may be electronic, electromagnetic, optical, or other signals capable of being received by communications interface 424. These signals may be provided to communications interface 424 via a communications path 426. Communications path 426 carries signals and may be implemented using wire or cable, fiber optics, a phone line, a cellular phone link, an RF link or other communications channels.

In this document, the terms “computer storage medium” and “computer readable storage medium” are used to generally refer to media such as removable storage unit 418, removable storage unit 422, and a hard disk installed in hard disk drive 412. Computer storage medium and computer readable storage medium may also refer to memories, such as main memory 408 and secondary memory 410, which may be memory semiconductors (e.g. DRAMs, etc.).

Computer programs (also called computer control logic) are stored in main memory 408 and/or secondary memory 410. Computer programs may also be received via communications interface 424. Such computer programs, when executed, enable computer system 400 to implement the embodiments described herein. In particular, the computer programs, when executed, enable processor device 404 to implement the processes of the embodiments, such as the stages in the methods illustrated by flowchart 300 of FIG. 3, discussed above. Accordingly, such computer programs represent controllers of computer system 400. Where an embodiment is implemented using software, the software may be stored in a computer storage medium and loaded into computer system 400 using removable storage drive 414, interface 420, and hard disk drive 412, or communications interface 424.

Embodiments of the invention also may be directed to computer program products including software stored on any computer readable storage medium. Such software, when executed in one or more data processing device, causes a data processing device(s) to operate as described herein. Examples of computer readable storage mediums include, but are not limited to, primary storage devices (e.g., any type of random access memory) and secondary storage devices (e.g., hard drives, floppy disks, CD ROMS, ZIP disks, tapes, magnetic storage devices, and optical storage devices, MEMS, nanotechnological storage device, etc.).

### CONCLUSION

The Summary and Abstract sections may set forth one or more but not all exemplary embodiments as contemplated by the inventor(s), and thus, are not intended to limit the present invention and the appended claims in any way.

The foregoing description of specific embodiments so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

1. A computer-implemented method for positioning image markers on a virtual canvas that represents a physical space captured in a collection of photographic images comprising:
positioning, by at least one computer processor, one or more virtual objects on the virtual canvas, each virtual object corresponding to a physical object located within the physical space and captured in a photographic image, wherein the position of each virtual object on the virtual canvas approximates the relative location of its corresponding physical object within the physical space based on the photographic image;
positioning, by the at least one computer processor, a plurality of image markers on the virtual canvas, each image marker corresponding to a photographic image's photo capture device, wherein each image marker's position corresponds to the relative location of a photo capture device and is determined relative to the position of at least one of one or more other ones of the plurality of image markers and the one or more virtual objects; and
creating, by the at least one computer processor, a link between a first image marker and a second image marker of the plurality of image markers, the link indicating a path, traversable by a user, within the physical space between the physical locations represented by the first and second image markers, wherein the link is created, at least in part, based on input from the user and the position of the one or more virtual objects.

2. The computer-implemented method of claim 1, further comprising:
orienting, by at least one computer processor, an image marker positioned on the virtual canvas such that a field-of-view captured in the corresponding photographic image aligns at least one physical object captured in the photographic image with its corresponding virtual object on the virtual canvas;
wherein the image marker is oriented based on the position of one or more other ones of the plurality of image markers.

3. The computer-implemented method of claim 2, wherein orienting the image marker is performed automatically based on the virtual location of at least one virtual object.

4. The computer-implemented method of claim 1, wherein positioning at least one image marker is performed automatically based on the virtual location of at least one virtual object.

5. The computer-implemented method of claim 1, further comprising:
determining an approximate physical dimension of the physical space based on the virtual location of each photographic image and the virtual location of each virtual object.

6. The computer-implemented method of claim 1, wherein positioning at least one virtual object is performed automatically based on the position of at least one image marker that corresponds to a photographic image that captured the virtual object's corresponding physical object.

7. The computer-implemented method of claim 1, further comprising:
building a virtual walk-through-style presentation of the physical space based on the position of the image markers on the virtual canvas and the links between the image markers, wherein the presentation allows the user to navigate from a first photographic image to a second photographic image along the path indicated by the link between the corresponding first and second image markers.

8. The computer-implemented method of claim 1, wherein the position of at least one virtual object on the virtual canvas is based on a measured distance between the virtual object's corresponding physical object and one other physical object.

9. The computer-implemented method of claim 1, wherein the physical objects that can be represented by virtual objects include walls, windows, doors, tables, or furniture.

10. A computer system for positioning a collection of photographic images on a virtual canvas that represents a physical space captured in the collection of photographic images, the computer system comprising:
one or more computer processors;
an object positioning module configured to position one or more virtual objects on the virtual canvas, each virtual object corresponding to a physical object located within the physical space and captured in a photographic image, wherein the position of each virtual object on the virtual canvas approximates the relative location of its corresponding physical object within the physical space based on the photographic image;
an image marker positioning module configured to position a plurality of image markers on the virtual canvas, each image marker corresponding to a photographic image's photo capture device, wherein each image marker's position corresponds to the relative location of a photo capture device and is determined relative to the position of at least one of one or more other ones of the plurality of image markers and the one or more virtual objects; and
an image marker linking module configured to create a link between a first image marker and a second image marker of the plurality of image markers, the link indicating a path, traversable by a user, within the physical space between the physical locations represented by the first and second image markers, wherein the link is created, at least in part, based on input from the user and the position of the one or more virtual objects;
wherein the one or more computer processors operate the object positioning module, the image marker positioning module and the image marker linking module.

11. The computer system of claim 10, further comprising:
an image marker orientation module, operated by the one or more computer processors, and configured to orient an image marker positioned on the virtual canvas such that a field-of-view captured in the corresponding photographic image aligns at least one physical object captured in the photographic image with its corresponding virtual object on the virtual canvas;
wherein the image marker is oriented based on the position of one or more other ones of the plurality of image markers.

12. The computer system of claim 11, wherein the image marker orientation module is further configured to orient the image marker automatically based on the virtual location of at least one virtual object.

13. The computer system of claim 10, wherein the image marker positioning module is further configured to position at least one image marker automatically based on the virtual location of at least one virtual object;

14. The computer system of claim 10, further comprising:
a scene dimension module, operated by the one or more computer processors, and configured to determine an approximate physical dimension of the physical space based on the virtual location of each photographic image and the virtual location of each virtual object.

15. The computer system of claim 10, wherein the object positioning module is further configured to position at least one virtual object automatically based on the position of at least one image marker that corresponds to a photographic image that captured the virtual object's corresponding physical object.

16. The computer system of claim 10, further comprising:
a scene construction module, operated by the one or more computer processors, and configured to build a virtual walk-through-style presentation of the physical space based on the position of the image markers on the virtual canvas and the links between the image markers, wherein the presentation allows the user to navigate from a first photographic image to a second photographic image along the path indicated by the link between the corresponding first and second image markers.

17. The computer system of claim 10, wherein the object positioning module is further configured to position at least one virtual object on the virtual canvas based on a measured distance between the virtual object's corresponding physical object and one other physical object.

18. The computer system of claim 10, wherein the physical objects that can be represented by virtual objects include walls, windows, doors, tables, or furniture.

19. A non-transitory computer-readable storage medium having instructions encoded thereon that, when executed by a computing device, causes the computing device to perform operations comprising:
positioning one or more virtual objects on the virtual canvas, each virtual object corresponding to a physical object located within the physical space and captured in a photographic image, wherein the position of each virtual object on the virtual canvas approximates the relative location of its corresponding physical object within the physical space based on the photographic image;
positioning a plurality of image markers on the virtual canvas, each image marker corresponding to a photographic image's photo capture device, wherein each image marker's position corresponds to the relative location of a photo capture device and is determined relative to the position of at least one of one or more other ones of the plurality of image markers and the one or more virtual objects; and
creating a link between a first image marker and a second image marker of the plurality of image markers, the link indicating a path, traversable by a user, within the physical space between the physical locations represented by the first and second image markers, wherein the link is created, at least in part, based on input from the user and the position of the one or more virtual objects.

20. The computer-readable storage medium of claim 19, further comprising:
orienting an image marker positioned on the virtual canvas such that a field-of-view captured in the corresponding photographic image aligns at least one physical object captured in the photographic image with its corresponding virtual object on the virtual canvas;
wherein the image marker is oriented based on the position of one or more other ones of the plurality of image markers.

21. The computer-readable storage medium of claim 20, wherein orienting the image marker is performed automatically based on the virtual location of at least one virtual object.

22. The computer-readable storage medium of claim 19, wherein positioning at least one image marker is performed automatically based on the virtual location of at least one virtual object.

23. The computer-readable storage medium of claim 19, further comprising:
determining an approximate physical dimension of the physical space based on the virtual location of each photographic image and the virtual location of each virtual object.

24. The computer-readable storage medium of claim 19, wherein positioning at least one virtual object is performed automatically based on the position of at least one image marker that corresponds to a photographic image that captured the virtual object's corresponding physical object.

25. The computer-readable storage medium of claim 19, further comprising:
building a virtual walk-through-style presentation of the physical space based on the position of the image markers on the virtual canvas and the links between the image markers, wherein the presentation allows the user to navigate from a first photographic image to a second photographic image along the path indicated by the link between the corresponding first and second image markers.

26. The computer-readable storage medium of claim 19, wherein the position of at least one virtual object on the virtual canvas is based on a measured distance between the virtual object's corresponding physical object and one other physical object.

27. The computer-readable storage medium of claim 19, wherein the physical objects that can be represented by virtual objects include walls, windows, doors, tables, or furniture.

28. A mobile computing device configured to position a collection of photographic images on a virtual canvas displayed on the mobile device, the virtual canvas representing a physical space captured in the collection of photographic images, the mobile computing device comprising:
one or more computer processors;
an object positioning module that, in response to a touch gesture, is configured to position one or more virtual objects on the virtual canvas, each virtual object corresponding to a physical object located within the physical space and captured in a photographic image, wherein the position of each virtual object on the virtual canvas approximates the relative location of its corresponding physical object within the physical space based on the photographic image;
an image marker positioning module that, in response to a touch gesture, is configured to position a plurality of image markers on the virtual canvas, each image marker corresponding to photographic image's photo capture device, wherein each image marker's position corresponds to the relative location of a photo capture device and is determined relative to the position of at least one of one or more other ones of the plurality of image markers and the one or more virtual objects; and
an image marker linking module that, in response to a touch gesture, is configured to create a link between a first image marker and a second image marker of the plurality of image markers, the link indicating a path, traversable by a user, within the physical space between the physical locations represented by the first and second image markers, wherein the link is created, at least in part, based on input from the user and the position of the one or more virtual objects;
wherein the one or more computer processors operate the object positioning module, the image marker positioning module and the image marker linking module.
